(19) United States
(12) Patent Application Publication
(10) Pub. No.: US 2005/0286605 A1
(43) Pub. Date: Dec. 29, 2005

(54) Electrode system for glass melting furnaces

(76) Inventor: Lothar Rott, Lohr am Main (DE)

Correspondence Address: Sonnenschein Nath & Rosenthal LLP, Suite 8000, 233 S. Wacker Drive, Chicago, IL, 60606, US

(21) Appl. No.: 11/156,118

(22) Filed: Jun. 17, 2005

(30) Foreign Application Priority Data
Jun. 29, 2004 (DE) 10 2004 031 242.7

(51) Int. Cl. H05B 7/06

(52) U.S. Cl. 373/93

(57) ABSTRACT

An electrode system for glass melting furnaces with a melting tank comprises at least one electrode holder (9) installed above the melt surface for inserting electrodes (7) from above through the melt surface (20). A connection device (27) for connection of the coaxial electricity and water supplies between the electrode holder (9) and the electrode (7) is located between the electrode holder and the electrode, whereby the electrode holder (9) has a coolant supply (24) for a coolant, which extends into the electrode (7). In order to simplify compatibility, flexibility and the ability to retrofit and convert electrode holders and electrodes, and to reduce the costs of the electrode system specified above:
a) the connection device (27) has a first robust, easily releaseable, threaded connection (8a) with a coaxial male thread (28a) for connection to the electrode holder (9) and a second robust, easily releaseable threaded connection (8b) with a coaxial female thread (31) for connection of the electrode (7), and that
b) the coolant supply (24) consists of a tube and an annular gap (26) surrounding the tube, both of which are led through the threaded connections (8a, 8b) and through the connection device (27).

### BACKGROUND OF THE INVENTION

The invention relates to an electrode system for glass melting furnaces with a melting tank and at least one electrode holder located above the melt surface for inserting electrodes through the melt surface and with an appendage as a coaxial electrical and water connection between the electrode holder and the electrode, whereby the electrode holder is fitted with a coolant supply passage that projects into the electrode.

It is known that glass melts in furnaces can be heated by means of electrodes that are introduced into the melt through the bottom or the side walls of the melting tank or from above through the furnace crown, and these can be advanced as necessary to compensate for the unavoidable corrosion. There is no known material that can permanently withstand the glass melt.

As it is necessary to exchange electrodes their installation through the bottom and/or the side walls of the melting tank is complicated in terms of both design and operation, as the openings that are made must be closed off in order to prevent the glass from draining out. Therefore there is now a tendency to install electrodes from above. These are also described as immersion or top electrodes.

Normally the electrodes and their holders—whether cooled or not—are connected to one another by means of electrically conducting threads, which must remain easily releaseable for the exchange or advancing of the electrodes. This poses a number of diametrically opposed problems. With non-cooled electrode connections the threads are normally outside the furnace chamber, which requires a much longer electrode or electrode section.

A further problem is that the materials used are susceptible to corrosion, in particular in the area of very aggressive batch and glass gall, that float on the glass melt as a result of the melting process. Up to the three phase boundary at the glass melt surface there is also the oxidizing effect of the oxygen contained in air, whereby it should be noted that molybdenum or tungsten for instance oxidize rapidly above about 550° C. to 600° C.

European patent no. 0 372 111 B1 (=U.S. Pat. No. 4,965,812) discloses a tubular electrode holder with a coaxial water supply pipe and a female thread at the inner end to receive the male thread of a complete electrode or an electrode segment made of highly heat resistant metals such as molybdenum, platinum, tungsten or their alloys. The electrodes are provided with coaxial bores, into which the end of the water supply pipe projects. When the electrode is unscrewed, a new electrode segment can be inserted to compensate for the wear of the electrode or segment already in operation. However, the electrode segment inserted is not designed as a permanent or long-term adapter for connection to the electrode holder. In particular it does not have a passage for the water supply tube and the supply and return flow of the cooling water. It is also subject to the same level of wear as those electrode segments already in operation.

Patents DE 195 08 433 C1 and EP 0 799 802 B1 disclose a tubular electrode holder to which a complex connection casing is attached at the inner end by means of two flanged connections screwed to its circumference. A coupling piece and a contact ring are clamped between the flanges of the lower flange connection. The coupling consists of a disc-shaped part and two coaxial appendages with male threads, the upper one of which is used for the attachment of flexible water and electricity connections and the lower for attachment of the electrode. The inner surface of the contact ring is conical to provide contact with the electrode, the ring has a system of cooling channels that mate with cooling channels in the coupling piece. In order to exchange the coupling piece and contact ring for a differently shaped electrode end it is necessary to dismantle the complete bottom part of the connection casing. Manufacturing and change procedures are therefore expensive in both material and financial terms.

Earlier types of top electrodes normally had a diameter of 63 mm. Over the years the diameter of the electrodes increased to 88.90 mm for example (=3.5 inches) in order to increase power. This places an immense load on the electrode holder. Even on electrodes with a diameter of 63 mm in normal operation there is sometimes corrosion in the transition between the molybdenum and the copper of the electrode holder at high currents. It was therefore established that it was not possible to reduce the size of an 88.90 mm electrode to 40 mm in the area of the connection to the electrode holder.

However it is very expensive to increase the diameter of an electrode holder, and transport, installation, operation and maintenance become more difficult. With many top electrodes extensive external scaling has also been found at the joint between steel and molybdenum. This means that the electrode holder must be reworked, but this is often not possible.

The object of the invention is therefore to improve the compatibility and flexibility, and to simplify retrofitting and conversion of electrode holders and electrodes, and reduce the costs of the electrode system described above.

### SUMMARY OF THE INVENTION

The object is accomplished in accordance with the invention described above in that
a) the connection device is fitted with a first robust, releaseable threaded connection with a coaxial male thread for connection to the electrode holder and a second robust, releaseable threaded connection with a coaxial female thread for connection of the electrode, and that
b) the coolant supply comprises a tube, which is surrounded by an annular gap, both of which are led through the threaded connections and the connection device.

In this way the object of the invention is completely accomplished, i.e. the compatibility and flexibility of the electrode holders are improved and retrofitting and conversion of the electrode holders to accept electrodes with different threaded connections is simplified, and the costs are reduced when the mechanical loading is high. The price difference between the old and the new electrode system means that it is now easy for the operator to change the connection between the electrode holder and the electrode using any chosen connection. The electrode material can also be freely chosen and is not limited to molybdenum.

The connection device and its threaded connections comprise a core made of a good electrical conductor such as copper or a copper alloy such as brass, encased in a sheath of chemical and heat resistant material such as stainless steel, and this arrangement offers effective protection against the chemical and thermal attack that occur in a furnace atmosphere with high temperatures of 1400° C. and above.

With regard to further embodiments of the invention it is particularly advantageous, if—either individually or in combination:
the connection device has a core for the conduction of electricity, made of a material containing copper and with an appendage to be screwed into the electrode holder and a coaxial female thread for the attachment of the electrode and a sleeve, the outside of which is at least partially surrounded by a sheath made of a material resistant to heat, oxidation and corrosion,
the electrode end of the sheath is closed off by a ring made of a material resistant to heat, oxidation and corrosion welded to the lower end of the sheath,
the electrode holder end of the sheath is closed off by a ring made of a material resistant to heat, oxidation and corrosion welded to the electrode holder,
the sleeve is completely enclosed by the sheath elements,
the core is made of a brass alloy,
the sheath components of the sleeve are each made of a stainless steel alloy,
the top edge of the sheath has notches for the attachment of tools, and/or, if
the electrode appendage is sealed against the connection device by a ring gasket.

Further advantageous embodiments according to the invention are given in the patent claims.

An example of the object according to the invention and its function and advantages are explained here in more detail with reference to FIGS. 1 and 2.

### BRIEF DESCRIPTION OF THE DRAWINGS

The following are shown:

FIG. 1 a partial vertical section through a glass melting furnace and a side view of the electrode swivel system and

FIG. 2 a partial vertical section through the threaded connections of the electrode holder and electrode.

### DETAILED DESCRIPTION OF THE PREFERRED EMBODIMENTS

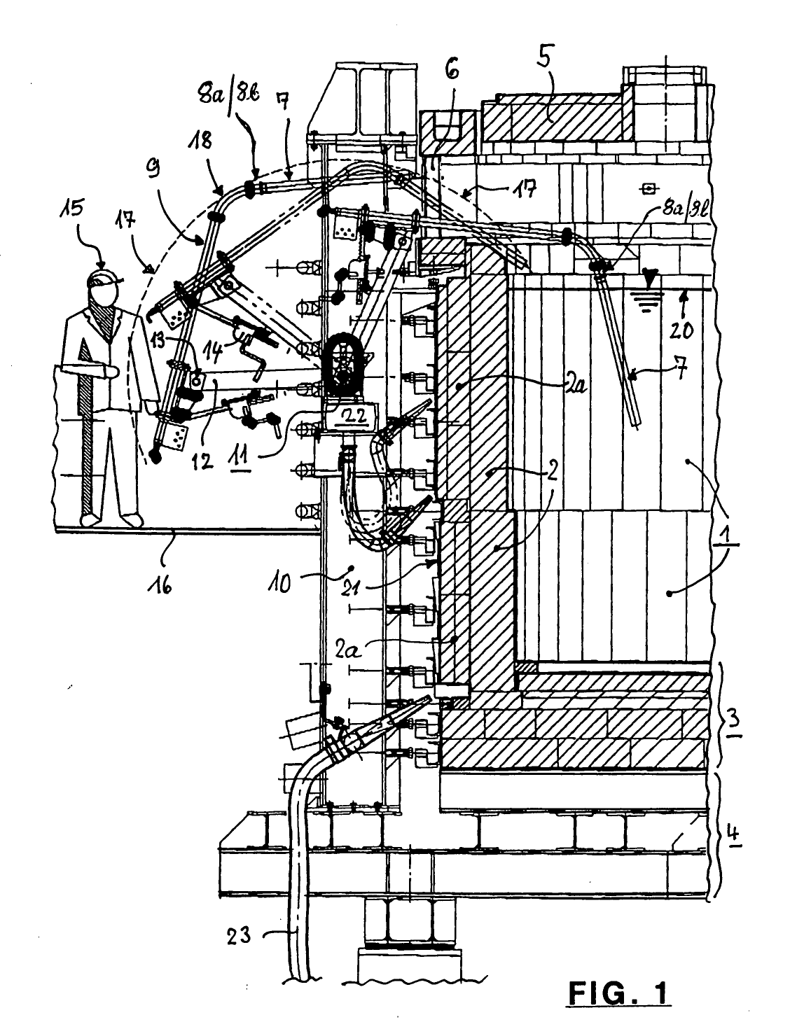

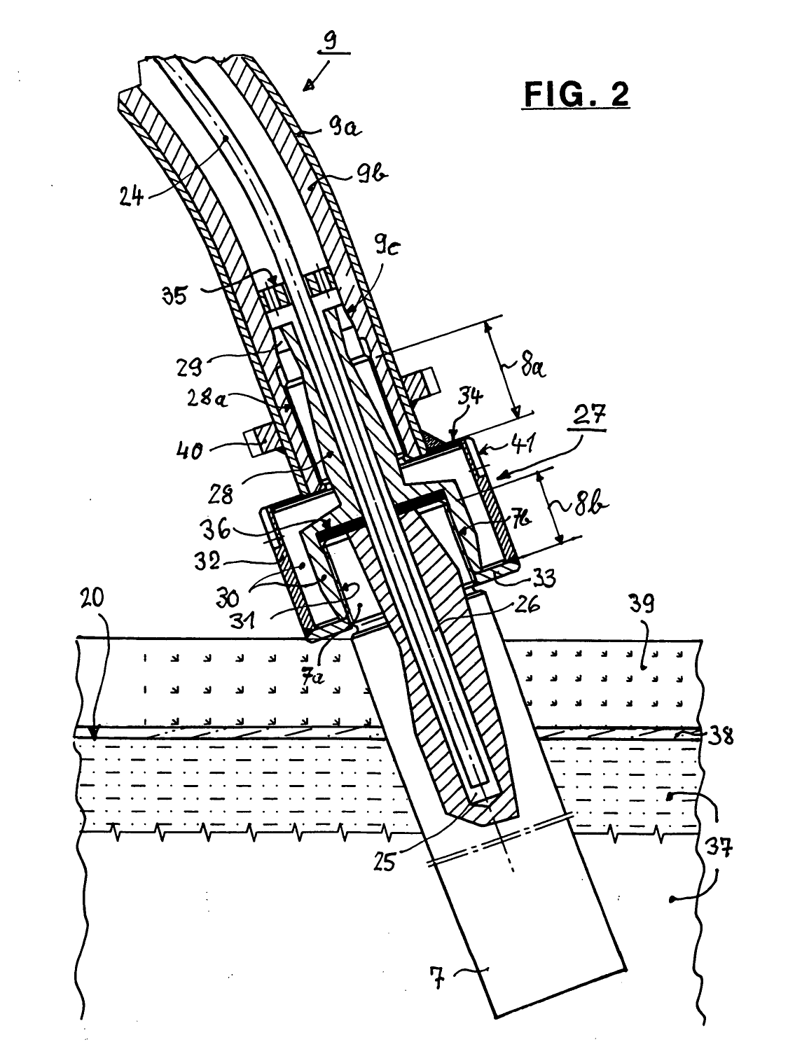

FIG. 1 shows a relevant section of a melting tank 1 with a vertical furnace wall 2 and an horizontal furnace bottom 3, that rests on supporting steelwork 4 of double T girders. The furnace is surmounted by a furnace crown 5. Between the latter and the furnace wall 2 there is at least one aperture 6 for insertion and retraction of an individual electrode 7, that is attached to an electrode holder 9 by means of threaded connections 8a/8b. Details of these threaded connections 8a/8b are shown in FIG. 2.

Outside the melting tank 1 there is a vertical support pillar 10 that is mounted on the supporting steelwork 4. This pillar 10 supports a swivel joint 11, around which the swivel lever 12 with a further joint 13 can be turned. The relative angular position and so the immersion depth of the electrode 7 can be adjusted by the jacking mechanism 14. The swivel movement is carried out by an operator 15, who stands on a working platform 16. The swivel radius 17 of the outermost point of an elbow 18 in the electrode holder 9 is indicated by a dotted arc, the height of the melt surface 20 by a straight line.

The outside of the furnace wall 2 with its thermal insulation 2a is covered by a metal casing 21, towards which several cooling nozzles, that are not detailed, are directed. These cooling nozzles are connected to the supply lines 22 and 23. It can be seen that the electrode 7 can be exchanged when the electrode holder 9 has been completely swivelled out.

FIG. 2 shows the inner end of the electrode holder 9, that has an outer tube 9a made of material that is resistant to heat, and chemical and mechanical attack, such as stainless steel, and an inner tube 9b that is made of a material that exhibits a good electrical conductivity, such as copper. The inner tube 9b is provided with a female thread and a conical contact surface 9c at its lower end. A coolant supply 24 in the form of a pipe is provided inside the electrode holder, whereby the inner end of the coolant supply pipe extends noticeably beyond the end of the electrode holder 9 and enters a cavity in the electrode 7. In this way a coolant, such as water, is applied to the end of the electrode 7 and returned through an annular gap 26 to the electrode holder 9.

A connection device 27 with good electrical conductive properties is fitted between the electrode 7 and the electrode holder 9. This connection device 27 is provided with an appendage 28 formed from a single piece with a male thread 28a and a conical surface 29, that seats in the opposite conical surface 9c of the inner tube 9b to provide a tight, electrical current-conducting connection. This creates the first threaded connection 8a. In addition the connection device 27 has a coupling piece 30 with a concentric female thread 31 with a freely selectable diameter. The coupling piece 30, the core of which is made of copper or a copper alloy, is surrounded by a sheath 32 made of material such as stainless steel that is resistant to chemical attack. This sheath 32 is closed at the bottom by a ring 33, welded onto the sheath 32. The opposite, upper end of the sheath 32 is enclosed by a ring welded to the external tube 9a of the electrode holder 9.

The top end of the electrode 7 has a shaped appendage 7a with a male thread 7b, that is screwed into the female thread 31 of the coupling 30. This threaded connection creates the second threaded connection 8b and another good electrical contact. The coolant supply 24 is centred in the electrode holder 9 by a perforated plate 35. The annular gap 26 is sealed off from the connection device 27 by a gasket 36.

The contents of the melting tank 1 shown in FIG. 1 comprise the glass melt 37, upon which floats first a gall layer 38 on top of which is a batch layer 39 comprising the glass raw materials, which may include glass cullet from recycled material.

A multi-facetted ring 40 is fitted at the bottom end of the electrode holder 9 for attachment of a tool. In order to produce a counter torque by means of a second tool notches 41 are provided in the top end of the connection device 27.

It can be seen that it is easy to adapt the electrode holder 9 for electrodes 7 of differing diameters by selecting and changing the connection device 27 which has a coupling piece 30 with a female thread 31. The liquid coolant supply passes through all threaded connections 8a and 8b, so that these also remain easy to release even when the electrode 7 has been in operation for a long period.

From the above description, it is apparent that the objects of the present invention have been achieved. While only certain embodiments have been set forth, alternative embodiments and various modifications will be apparent from the above description to those skilled in the art. These and other alternatives are considered equivalents and within the spirit of the scope of the present invention. It should be understood that I wish to embody within the scope of the patent warranted hereon all such modifications as reasonably and properly come within the scope of my contribution to the art.

REFERENCE NUMBERS

| | |
|---|---|
| 1 | Melting tank |
| 2 | Furnace wall |
| 2a | Thermal insulation |
| 3 | Furnace bottom |
| 4 | Supporting steelwork |
| 5 | Furnace crown |
| 6 | Aperture |
| 7 | Electrode |
| 7a | Appendage |
| 7b | Male thread |
| 8a | Threaded connection |
| 8b | Threaded connection |
| 9 | Electrode holder |
| 9a | Outer tube |
| 9b | Inner tube |
| 9c | Conical surface |
| 10 | Support pillar |
| 11 | Swivel joint |
| 12 | Swivel lever |
| 13 | Joint |
| 14 | Jacking mechanism |
| 15 | Operator |
| 16 | Working platform |
| 17 | Swivel radius |
| 18 | Elbow |
| 19 | Swivel joint |
| 20 | Melt surface |
| 21 | Metal casing |
| 22 | Supply line |
| 23 | Supply line |
| 24 | Coolant supply |
| 25 | Cavity |
| 26 | Annular gap |
| 27 | Connection device |
| 28 | Appendage |
| 28a | Male thread |
| 29 | Conical surface |
| 30 | Coupling piece |
| 31 | Female thread |
| 32 | Sheath |
| 33 | Ring |
| 34 | Ring |
| 35 | Perforated plate |
| 36 | Gasket |
| 37 | Glass melt |
| 38 | Gall layer |
| 39 | Batch layer |
| 40 | Ring |
| 41 | Notches |

1-9. (canceled)

10. An electrode system for glass melting furnaces having a melting tank and at least one electrode holder installed above a melt surface for inserting electrodes from above through the melt surface and each electrode holder having a connection device for coaxial electric and water connections between the electrode holder and an electrode, comprising:
a) the connection device having a first robust, easily released, threaded connection with a coaxial male thread for connection to the electrode holder and a second robust, releasable threaded connection with a coaxial female thread for connection of the electrode, and
b) a coolant supply comprising a tube, around which there is an annular gap, both the tube and the gap being led through the threaded connections and through the connection device into the electrode.

11. An electrode system according to claim 10, wherein the connection device has a core made of a copper-containing material with an appendage for screwing into the electrode holder and a coaxial female thread for connection of the electrode and a coupling, the outside of which is at least partially surrounded by a sheath made of a material resistant to heat, oxidation and corrosion.

12. An electrode system according to claim 11, wherein the sheath is closed off from the electrode by a ring made of a material resistant to heat, oxidation and corrosion that is welded to a lower end of the sheath.

13. An electrode system according to claim 11, wherein the sheath is closed off from the electrode holder by a ring made of a material resistant to heat, oxidation and corrosion that is welded to the electrode holder.

14. An electrode system according to claim 11, wherein the coupling is completely surrounded by sheath components.

15. An electrode system with a connection device according to claim 14, wherein the sheath components of the coupling are each made of a stainless steel alloy.

16. An electrode system with a connection device according to claim 11, wherein the core is made of a brass alloy.

17. An electrode system with a connection device according to claim 11, wherein the upper edge of the sheath has notches for the application of a tool.

18. An electrode system with a connection device according to claim 11, wherein the appendage of the electrode is sealed off from the connection device by a gasket.

19. An electrode system for glass melting furnaces having a melting tank for receiving a glass melt, an electrode and at least one electrode holder for inserting the electrode into the glass melt comprising a connection device to provide electric and water connections between the electrode holder and an electrode, comprising:
a) the connection device having a first threaded connection for connection to the electrode holder and a second threaded connection for connection of the electrode, and
b) a coolant supply comprising a tube surrounded by an annular gap, both the tube and the gap extending through the threaded connections and through the connection device into the electrode.

20. An electrode system according to claim 19, wherein the first threaded connection comprises a male thread on the connection device.

21. An electrode system according to claim 19, wherein the second threaded connection comprises a female thread on the connection device.

22. An electrode system according to claim 19, wherein the first threaded connection and the second threaded connection are coaxial.

23. An glass melting furnace comprising:
a melting tank for receiving a glass melt,
at least one electrode,
at least one electrode holder for inserting the electrode into the glass melt,
the electrode holder having a connection device for electric and water connections between the electrode holder and the electrode,
the connection device having a first threaded connection for connection to the electrode holder and a second threaded connection for connection of the electrode, and
a coolant supply comprising a tube surrounded by an annular gap, both the tube and the gap extending through the threaded connections and through the connection device into the electrode.

24. A glass melting furnace according to claim 23, wherein the first threaded connection comprises a male thread on the connection device.

25. A glass melting furnace according to claim 23, wherein the second threaded connection comprises a female thread on the connection device.

26. A glass melting furnace according to claim 23, wherein the first threaded connection and the second threaded connection are coaxial.

27. A glass melting furnace according to claim 23, wherein the electrode holder is installed above a melt surface in the melting tank for inserting the electrode from above through the melt surface.

28. A glass melting furnace according to claim 23, wherein the electric and water connections between the electrode holder and the electrode are coaxial.
